(19) United States
(12) Patent Application Publication
(10) Pub. No.: US 2026/0278763 A1
(43) Pub. Date: Sep. 17, 2026

(54) FIELD-GROWN COTTON GROWTH STATUS ASSESSMENT AND PREDICTION SYSTEM BASED ON UNMANNED AERIAL VEHICLE RED-GREEN-BLUE IMAGERY

(71) Applicant: Institute of Cotton Research, Chinese Academy of Agricultural Sciences, Anyang (CN)

(72) Inventors: Xiaoyu Zhi, Anyang (CN); Yabing Li, Anyang (CN); Yingchun Han, Anyang (CN); Yaping Lei, Anyang (CN); Beifang Yang, Anyang (CN); Shiwu Xiong, Anyang (CN); Yahui Jiao, Anyang (CN); Yunzhen Ma, Anyang (CN); Shilong Shang, Anyang (CN)

(21) Appl. No.: 19/438,525

(22) Filed: Dec. 31, 2025

(30) Foreign Application Priority Data
Mar. 13, 2025 (CN) 202510297855.3

(51) Int. Cl. G06T 7/00; A01C 21/00; G06T 5/70; G06T 7/11; G06T 7/529; G06T 7/73

(52) U.S. Cl. CPC G06T 7/0004; A01C 21/007; G06T 5/70; G06T 7/11; G06T 7/529; G06T 7/75; G06T 2200/24; G06T 2200/32; G06T 2207/10024; G06T 2207/10032; G06T 2207/20084

(57) ABSTRACT

A field-grown cotton growth status assessment and prediction system based on unmanned aerial vehicle (UAV) red-green-blue (RGB) imagery includes interconnected modules: a data acquisition module, configured to collect initial image data; a data processing module, configured to perform denoising, distortion correction, orthophoto mosaic, and illumination correction to obtain standardized image data; an image mining module, configured to perform image segmentation and object detection, and extract cotton canopy features and growth indicators; a comprehensive assessment module, configured to construct a growth status assessment model to obtain a comprehensive growth condition score and evaluation metrics; a growth prediction module, configured to incorporate yield-related factors to perform yield prediction and growth anomaly warnings; and a real-time monitoring and decision support module, configured to visually display assessment and prediction results and automatically generate decision support. The system can comprehensively analyze field-grown cotton growth status, enhancing comprehensiveness, accuracy, and efficiency of assessment and prediction.

### CROSS-REFERENCE TO RELATED APPLICATION

This application claims priority of Chinese Patent Application No. 202510297855.3, filed on Mar. 13, 2025, the entire contents of which are incorporated herein by reference.

### TECHNICAL FIELD

The present disclosure relates to the technical field of plant growth assessment, and more particularly, to a field-grown cotton growth status assessment and prediction system based on unmanned aerial vehicle (UAV) red-green-blue (RGB) imagery.

### BACKGROUND

Cotton is a globally significant economic crop, serving as a primary raw material for the textile industry. It is widely used in the production of clothing, home textiles, and other products, supporting the global textile supply chain. Investigating the comprehensive growth status of cotton can optimize cultivation management practices, thereby increasing crop yield and improving fiber quality. Understanding the spatial and temporal variation characteristics of cotton growth can also facilitate targeted fertilization, irrigation, and pest control, which reduces agricultural input costs.

With the advancement of science and technology, current methods and technologies for assessing the comprehensive growth profile of cotton plants include, but are not limited to, hyperspectral imaging and Internet of Things (IoT) sensors. However, most of these techniques are often cost-prohibitive and face data processing constraints, hindering adoption in large scale. Using UAV RGB imagery to assess cotton growth status can reduce operational costs. Additionally, the high flexibility of UAVs can allow for rapid coverage of large planting areas. However, existing techniques for assessing cotton growth status using UAV RGB imagery still face several challenges. (1) High data processing complexity: the large volume of RGB image data leads to relatively low processing efficiency, and image processing algorithms are sensitive to lighting conditions, which may compromise the reliability of results. (2) Lack of multi-factor integrated analysis: current research primarily focuses on single indicators (e.g., canopy coverage), with insufficient integration of multiple factors (such as soil and meteorological data). (3) Insufficient real-time capability: time lags exist between data acquisition and analysis, hindering real-time monitoring and dynamic assessment.

### SUMMARY

To overcome these deficiencies, an objective of the present disclosure is to provide a field-grown cotton growth status assessment and prediction system based on UAV RGB imagery. This system can perform a comprehensive analysis of cotton growth by integrating multiple factors, thereby enhancing the comprehensiveness, accuracy, and efficiency of assessment and prediction. Additionally, this system can conduct real-time monitoring and support intelligent decision-making throughout the entire cotton growth cycle, thereby improving the efficiency and precision of agricultural management and propelling cotton precision agriculture into a new digital and intelligent stage.

To realize the above objective, the present disclosure provides the following technical solution: a field-grown cotton growth status assessment and prediction system based on UAV RGB imagery includes:
a data acquisition module, configured to select a UAV equipped with an RGB camera, preset a flight path and image acquisition parameters according to terrain of a field plot, and perform data acquisition to obtain initial image data;
a data processing module, configured to perform denoising, distortion correction, orthophoto mosaic, and illumination correction on the initial image data to obtain standardized image data;
an image mining module, configured to perform image segmentation and object detection on the standardized image data to obtain cotton target information, and extract canopy coverage, plant height, color features and vegetation indices, as well as textural and spatial structural features from the cotton target information, ultimately obtaining cotton canopy profile features and growth indicators;
a comprehensive assessment module, configured to incorporate environmental data, train a machine learning model using the environmental data and the growth indicators to obtain a growth status assessment model, and utilize the assessment model to obtain a comprehensive growth condition score and evaluation metrics;
a growth prediction module, configured to perform yield prediction by incorporating yield-related factors based on the growth status assessment model, and to issue growth anomaly warnings by presetting growth anomaly thresholds; and
a real-time monitoring and decision support module, configured to utilize a cloud service platform for distributed data storage and management, employ WebGIS technology to visually display comprehensive assessment and growth prediction results for individual cotton plots, and automatically generate and execute decision support for automated field management based on the comprehensive assessment and growth prediction results;
in which the data acquisition module, the data processing module, the image mining module, the comprehensive assessment module, the growth prediction module, and the real-time monitoring and decision support module are interconnected.

Alternatively, the data acquisition module includes:
a hardware configuration unit, configured to select a UAV, and equip the selected UAV with an RGB camera mounted on a compatible three-axis gimbal to achieve image stabilization;
a flight path planning unit, configured to automatically generate a flight path using UAV route planning software, and to set a forward overlap degree and a side overlap degree for image capture; and
a parameter configuration unit, configured to set a flight altitude and an imaging resolution of the UAV according to cotton growth stages, and to execute data acquisition, ultimately obtaining the initial image data.

Alternatively, the data processing module includes:
a denoising and distortion correction unit, configured to perform denoising on the initial image data using an automatic batch processing tool and a denoising algorithm, and to perform distortion correction on image edges using camera calibration parameters;
an orthophoto mosaic unit, configured to process overlapping images from the initial image data using photogrammetric software by performing feature point matching and image stitching, outputting a georeferenced orthophoto; and
an illumination correction unit, configured to deploy a gray-level card within a UAV flight area to record reference reflectance values, perform color calibration on the initial image data based on the values, and integrate a radiometric correction algorithm into the photogrammetric software to standardize image brightness and color.

Alternatively, the image mining module includes:
a data annotation unit, configured to perform pixel-level annotation on the standardized image data using annotation tools, generating segmentation masks to distinguish cotton plants from a soil background, and to apply bounding box annotations to individual cotton plants and disease/pest infestation areas;
an image segmentation unit, configured to: construct a first initial model by selecting a convolutional neural network (CNN), incorporating an attention mechanism, a multi-scale feature extraction module, and depthwise separable convolutions into the selected CNN; train the first initial model using a deep learning framework to obtain a segmentation model; and employ the segmentation model to process the standardized image data and output a binary image containing overall distribution information of the cotton canopy;
a target detection unit, configured to develop an object detection model by integrating YOLOv5 with multi-task learning, and to utilize the object detection model to detect targets within the binary image, outputting positional information including locations of individual cotton plants or disease/pest infestation areas;
a result fusion unit, configured to fuse the binary image with the positional information to obtain cotton target information; and
a canopy profile and growth indicator extraction unit, configured to extract canopy coverage, plant height, color features and vegetation indices, as well as textural and spatial structural features from the cotton target information, ultimately obtaining the associated canopy profile features and growth indicators.

Alternatively, the canopy profile and growth indicator extraction unit includes:
a canopy coverage calculation subunit, configured to calculate canopy coverage by determining a percentage of cotton canopy pixels in the binary image, and assess whether growth progress is normal based on the canopy coverage combined with the cotton growth stages;
a plant height estimation subunit, configured to estimate plant height by combining the orthophoto with a digital surface model (DSM), and to output a spatial distribution map of plant height for identifying areas with anomalous growth;
a textural and spatial structural feature extraction subunit, configured to extract textural features from the standardized image data using a gray-level co-occurrence matrix (GLCM), and to calculate population density and inter-plant spacing of cotton plants, ultimately obtaining the spatial structural features; and
a color feature and vegetation index calculation subunit, configured to extract RGB color features from the standardized image data, design RGB vegetation indices by integrating the textural features with the color features, and assess cotton health status and identify disease/pest infestation areas based on spatial distribution of the RGB vegetation indices.

Alternatively, the comprehensive assessment module includes:
a data fusion unit, configured to acquire soil data, meteorological data, and geographic information data for cotton fields to obtain environmental data, perform spatial and temporal alignment between the environmental data and the standardized image data, and fuse the aligned environmental data with the extracted growth indicators to obtain a comprehensive dataset;
a model construction unit, configured to build an initial model using ensemble learning methods, define input variables (including canopy coverage, plant height, vegetation indices, textural features, and environmental data) and output variables (including a comprehensive growth status score, a health index, and a stress index), and train the model using the comprehensive dataset to obtain the growth status assessment model; and
an indicator quantification unit, configured to generate a spatial distribution map based on the comprehensive growth status score, integrate the score with the health index and stress index to obtain the evaluation metrics, and perform a comprehensive assessment using the metrics.

Alternatively, an expression for the comprehensive growth status score is formulated as:

$$S = {ω}_{1} \cdot C + {ω}_{2} \cdot H + {ω}_{3} \cdot VI + {ω}_{4} \cdot T$$

where S represents a comprehensive growth status score, C represents canopy coverage, H represents plant height, VI represents a vegetation index, T represents textural features, and ω₁, ω₂, ω₃, and ω₄ are weight coefficients for each indicator;
an expression for the health index is formulated as:

$$HI = α \cdot VI + β \cdot T$$

where HI represents a health index, and α and β are weight parameters; and
an expression for the stress index is formulated as:

$$AI = {γ}_{1} \cdot ( 1 - {E}_{soil} ) + {γ}_{2} \cdot \vert {E}_{temp} - {T}_{opt} \vert$$

where AI represents the stress index, Eₛₒᵢₗ represents soil moisture, Eₜₑₘₚ represents temperature, Tₒₚₜ represents an optimal growth temperature for cotton, and γ₁ and γ₂ are weight parameters.

Alternatively, the growth prediction module includes:
a yield prediction unit, configured to fuse the canopy coverage, plant height, vegetation index, textural features, environmental data, and yield-related factors (including plant density and boll load) to generate a yield prediction dataset; utilize the yield prediction dataset to train a yield prediction model, which incorporates an environmental correction factor to adjust output values; and employ the yield prediction model to output predicted yield per plant and predicted yield per unit area; and
a growth anomaly unit, configured to set thresholds for the comprehensive growth status score, health index, and stress index based on the output values from the growth status assessment model, determine whether a cotton field plot constitutes an anomalous area according to the thresholds, and automatically generate an alert message if so.

Alternatively, an expression for the predicted yield per plant area is given by:

$${Y}_{single} = B \cdot {W}_{boll}$$

where Y_{single} represents the predicted yield per plant, B represents a boll load, and W_{boil} is a weight per boll; and
an expression for the predicted yield per unit area is given by:

$${Y}_{yield} = D \cdot {Y}_{single} \cdot ( 1 - {k}_{1} \cdot \vert {E}_{soil} - {E}_{opt} \vert - {k}_{2} \cdot \vert {E}_{temp} - {T}_{opt} \vert )$$

where Y_{yield} represents the predicted yield per unit area, D represents plant density, Eₒₚₜ represents optimal soil moisture, Tₒₚₜ represents optimal growth temperature, and k₁ and k₂ are environmental correction coefficients.

Alternatively, the real-time monitoring and decision support module includes:
a data storage unit, configured to store structured data in a relational database and manage unstructured data via object storage using a cloud service platform, and to perform real-time data ingestion through application programming interfaces (APIs);
a monitoring and visualization unit, configured to develop a responsive interface supporting multi-terminal access using front-end frameworks, and to leverage WebGIS technology for real-time display of processing results from the image mining module, the comprehensive assessment module, and the growth prediction module on the interface in real time through map overlays, field plot views, and heatmaps; and
a decision support unit, configured to generate fertilization and irrigation recommendations, disease and pest control management suggestions, climate change trend analysis, and pest/disease pattern analysis based on the processing results from the image mining module, the comprehensive assessment module, and the growth prediction module.

In the present disclosure, the field-grown cotton growth status assessment and prediction system based on UAV RGB imagery has the following technical effects:
1. Efficient data processing: in the present disclosure, by utilizing automated data processing and comprehensive image mining, multi-dimensional features including canopy coverage, plant height, color features, vegetation indices, and textural and spatial structural characteristics could reflect results typically obtained from near-infrared or hyperspectral data, allowing for a comprehensive and accurate representation of cotton growth status, thereby providing a reliable data foundation for subsequent growth assessment and prediction.
2. High accuracy in comprehensive assessment: in the present disclosure, through the integration of UAV image data with external environmental data (e.g., soil and meteorological) across spatial and temporal dimensions, multi-dimensional comprehensive assessment data are generated to construct a growth status assessment model, which obtains quantified outputs including a comprehensive growth status score and a health index. This approach not only accurately captures the overall growth condition of cotton but also significantly enhances the scientific validity and reliability of the assessment.
3. Real-time monitoring and intelligent decision support: in the present disclosure, by establishing a cloud service platform, the system can achieve efficient data storage and management with real-time data uploading. Through an interactive visualization interface, comprehensive assessment and growth prediction results can be displayed in real time, supporting continuous monitoring and multi-terminal access. Furthermore, the system can automatically generate actionable recommendations, such as fertilization and irrigation guidance, pest and disease control strategies, and conduct analysis on climate change trends and pest/disease patterns, thereby enhancing the intelligence level of agricultural management.

The technical solutions of the present disclosure are further described below in combination with embodiments and accompanying drawings.

### BRIEF DESCRIPTION OF THE DRAWINGS

To more clearly illustrate the technical solutions in the embodiments of the present disclosure, the accompanying drawings used in the embodiments or in the description of the related art are briefly described below. Obviously, the drawings described below are only some embodiments of the present disclosure. For those of ordinary skill in the art, other drawings may be obtained based on these drawings without creative efforts.

FIG. 1 is a schematic structural diagram of a system according to an embodiment of the present disclosure;

FIG. 2 is a schematic flow diagram of image mining according to an embodiment of the present disclosure; and

FIG. 3 is a schematic flow diagram of assessment and prediction according to an embodiment of the present disclosure.

### DETAILED DESCRIPTION

The technical solutions in the embodiments of the present disclosure are further described clearly and completely below in combination with the accompanying drawings. Obviously, the embodiments described are only some, rather than all, of the embodiments of the present disclosure. Based on the embodiments of the present disclosure, all other embodiments obtained by those of ordinary skill in the art without creative efforts fall within the scope of protection of the present disclosure.

To make the aforementioned objectives, features, and advantages of the present disclosure more apparent and comprehensible, the present disclosure is further described in detail below with reference to the drawings and specific implementations.

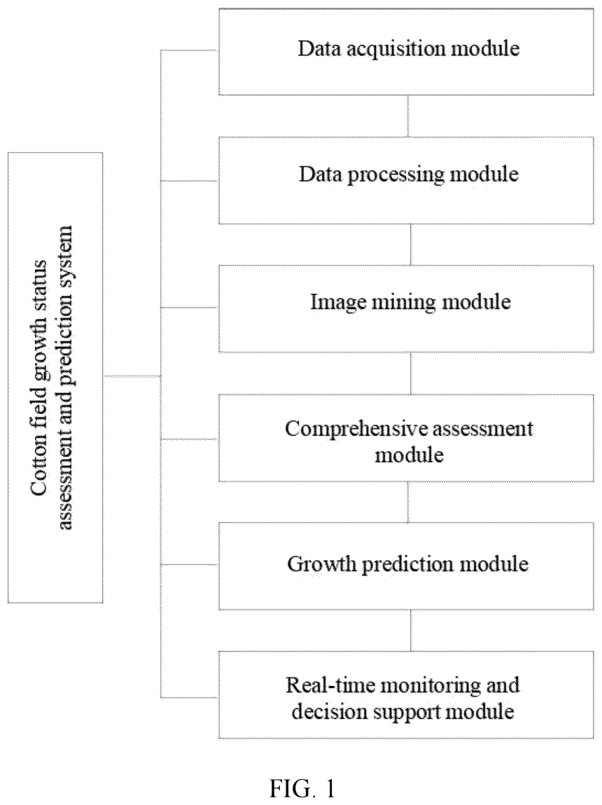

As shown in FIG. 1, the present disclosure provides a field-grown cotton growth status assessment and prediction system based on UAV RGB imagery, including interconnected modules: a data acquisition module, a data processing module, an image mining module, a comprehensive assessment module, a growth prediction module, and a real-time monitoring and decision support module.

### 1. Data Acquisition Module

This module is configured to select a UAV equipped with an RGB camera, preset a flight path and image acquisition parameters according to terrain of a field plot, and perform data acquisition to obtain initial image data. Additionally, the data acquisition module includes:

### 1.1 Hardware Configuration Unit

This unit is configured to select a UAV and equip the selected UAV with an RGB camera mounted on a compatible three-axis gimbal to achieve image stabilization, thereby reducing motion-induced blur in the captured images.

### 1.2 Flight Path Planning Unit

This unit is configured to perform mission planning by utilizing UAV route planning software (e.g., DJI Pilot, Pix4Dcapture, UGCS), and input cotton field boundaries and terrain data to automatically generate a flight path covering the entire area.

The unit is also configured to set a forward overlap degree to 70%-80% to ensure sufficient overlap between consecutive images for stitching, and a side overlap degree to 60%-70% to prevent gaps during image mosaic generation.

### 1.3 Parameter Configuration Unit

This unit is configured to set a flight altitude and an imaging resolution of the UAV according to cotton growth stages, and to execute data acquisition, ultimately obtaining the initial image data.

### 2. Data Processing Module

This module is configured to perform denoising, distortion correction, orthophoto mosaic, and illumination correction on the initial image data to obtain standardized image data. Additionally, the data processing module includes:

### 2.1 Denoising and Distortion Correction Unit

This unit is configured to perform denoising on the initial image data using an automatic batch processing tool (e.g., OpenCV or ImageJ) and denoising algorithms (such as mean filtering or Gaussian filtering), thereby minimizing interference with image features.

This unit is also configured to perform distortion correction on image edges using camera calibration parameters (e.g., focal length, distortion coefficients) to rectify edge bending caused by lens optical characteristics. This can be automated using open-source tools, such as the cv2.undistort( ) function in OpenCV.

### 2.2 Orthophoto Mosaic Unit

This unit is configured to process overlapping images from the initial image data using photogrammetric software (e.g., Pix4D, Agisoft Metashape) by performing feature point matching and image stitching, thereby outputting a georeferenced orthophoto.

### 2.3 Illumination Correction Unit

This unit is configured to deploy a gray-level card within a UAV flight area to record reference reflectance values, perform color calibration on the initial image data based on the values to reduce illumination variations, and integrate a radiometric correction algorithm (e.g., empirical line calibration, ELC) into the photogrammetric software to standardize image brightness and color.

### 3. Image Mining Module

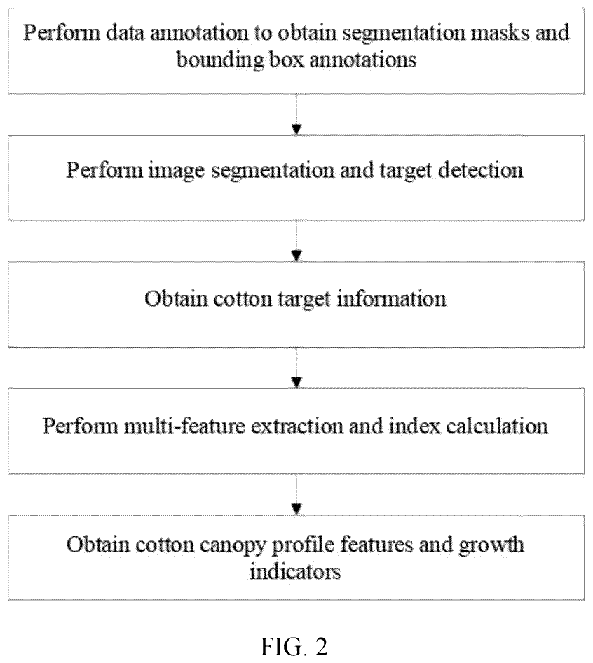

As shown in FIG. 2, this module is configured to perform image segmentation and object detection on the standardized image data to obtain cotton target information, and extract canopy coverage, plant height, color features, and vegetation indices, as well as textural and spatial structural features from the cotton target information, ultimately obtaining cotton canopy profile features and growth indicators. Additionally, the image mining module includes:

### 3.1 Data Annotation Unit

This unit is configured to perform pixel-level annotation on the standardized image data using annotation tools (e.g., Labelme, LabelImg), generating segmentation masks to distinguish cotton plants from a soil background, and to apply bounding box annotations to individual cotton plants and disease/pest infestation areas.

### 3.2 Image Segmentation Unit

This unit is configured to: construct a first initial model by selecting a CNN (e.g., MobileNet U-Net), incorporating an attention mechanism (such as an SE or CBAM module), a multi-scale feature extraction module, and depthwise separable convolutions (to reduce parameter count and computational load) into the selected CNN; train the first initial model using a deep learning framework to obtain a segmentation model; and employ the segmentation model to process the standardized image data and output a binary image ((where cotton plant regions are labeled 1 and soil background is labeled 0), thereby providing the foundation for subsequent feature extraction. The binary image contains overall distribution information of the cotton canopy.

### 3.3 Target Detection Unit

This unit is configured to develop an object detection model by integrating YOLOv5 with multi-task learning (which simultaneously outputs locations of cotton plants and disease/pest areas to improve detection efficiency), and to utilize the object detection model to detect targets within the binary image, outputting positional information including locations of individual cotton plants or disease/pest infestation areas.

### 3.4 Result Fusion Unit

This unit is configured to fuse the binary image with the positional information to obtain cotton target information.

### 3.5 Canopy Profile and Growth Indicator Extraction Unit

This unit is configured to extract canopy coverage, plant height, color features, and vegetation indices, as well as textural and spatial structural features from the cotton target information, thereby obtaining the associated canopy profile features and growth indicators.

The canopy profile and growth indicator extraction unit includes:

### 3.51 Canopy Coverage Calculation Subunit

This subunit is configured to calculate canopy coverage by determining a percentage of cotton canopy pixels in the binary image, and assess whether growth progress is normal based on the canopy coverage combined with the cotton growth stages (e.g., seedling, budding, flowering-boll, and boll-opening stages).

### 3.52 Plant Height Estimation Subunit

This subunit is configured to estimate plant height by combining the orthophoto with a DSM, and to output a spatial distribution map of plant height for identifying areas with anomalous growth (e.g., excessively tall or short plants).

### 3.53 Textural and Spatial Structural Feature Extraction Subunit

This subunit is configured to extract textural features from the standardized image data using a GLCM, and to calculate population density (by counting cotton plants per unit area) and inter-plant spacing (by analyzing the uniformity of plant distribution) of cotton plants, thereby obtaining the spatial structural features.

### 3.54 Color Feature and Vegetation Index Calculation Subunit

This subunit is configured to extract RGB color features (such as mean brightness and green component intensity) from the standardized image data, design RGB vegetation indices by integrating the textural features with the color features, and assess cotton health status and identify disease/pest infestation areas based on spatial distribution of the RGB vegetation indices.

### 4. Comprehensive Assessment Module

This subunit is configured to incorporate environmental data, train a machine learning model using the environmental data and the growth indicators to obtain a growth status assessment model, and utilize the assessment model to obtain a comprehensive growth condition score and evaluation metrics. Additionally, the comprehensive assessment module includes:

### 4.1 Data Fusion Unit

This unit is configured to acquire soil data, meteorological data, and geographic information data for cotton fields to obtain environmental data, perform spatial and temporal alignment between the environmental data and the standardized image data, and fuse the aligned environmental data with the extracted growth indicators to obtain a comprehensive dataset.

Spatial alignment: the environmental data is aligned with the geographic coordinate system (e.g., WGS84) of the UAV imagery. Using a geographic information system (GIS) platform (such as ArcGIS or QGIS), a spatial overlay is performed to map soil and meteorological data onto the cotton field area, generating a multi-layer spatial information map.

Temporal alignment: timestamps are standardized to synchronize environmental data with the UAV flight time, ensuring data timeliness.

During data fusion, integration is performed at the field-plot or pixel-level in the spatial dimension, and data are aggregated within time windows such as daily, weekly, or monthly in the temporal dimension.

### 4.2 Model Construction Unit

This unit is configured to build an initial model using ensemble learning methods (e.g., Random Forest, XGBoost), define input variables, including canopy coverage, plant height, vegetation indices, textural features, and environmental data (soil moisture, nutrients, meteorological data) and output variables, including a comprehensive growth status score (0-100), a health index (reflecting plant health), and a stress index (reflecting the impact of adversities such as drought and pests/diseases), and train the model using the comprehensive dataset to obtain the growth status assessment model.

An expression for the comprehensive growth status score is formulated as:

$$S = {ω}_{1} \cdot C + {ω}_{2} \cdot H + {ω}_{3} \cdot VI + {ω}_{4} \cdot T$$

where S represents a comprehensive growth status score, C represents canopy coverage, H represents plant height, VI represents a vegetation index, T represents textural features, and ω₁, ω₂, ω₃, and ω₄ are weight coefficients for each indicator.

An expression for the health index is formulated as:

$$HI = α \cdot VI + β \cdot T$$

where HI represents a health index, and α and β are weight parameters.

An expression for the stress index is formulated as:

$$AI = {γ}_{1} \cdot ( 1 - {E}_{soil} ) + {γ}_{2} \cdot \vert {E}_{temp} - {T}_{opt} \vert$$

where AI represents the stress index, Eₛₒᵢₗ represents soil moisture, Eₜₑₘₚ represents temperature, Tₒₚₜ represents an optimal growth temperature for cotton, and γ₁ and γ₂ are weight parameters.

### 4.33 Indicator Quantification Unit

This unit is configured to generate a spatial distribution map based on the comprehensive growth status score, integrate the score with the health index and stress index to obtain the evaluation metrics, and perform a comprehensive assessment using the metrics.

### 5. Growth Prediction Module

This module is configured to perform yield prediction by incorporating yield-related factors based on the growth status assessment model, and to issue growth anomaly warnings by presetting growth anomaly thresholds. The growth prediction module includes:

### 5.1 Yield Prediction Unit

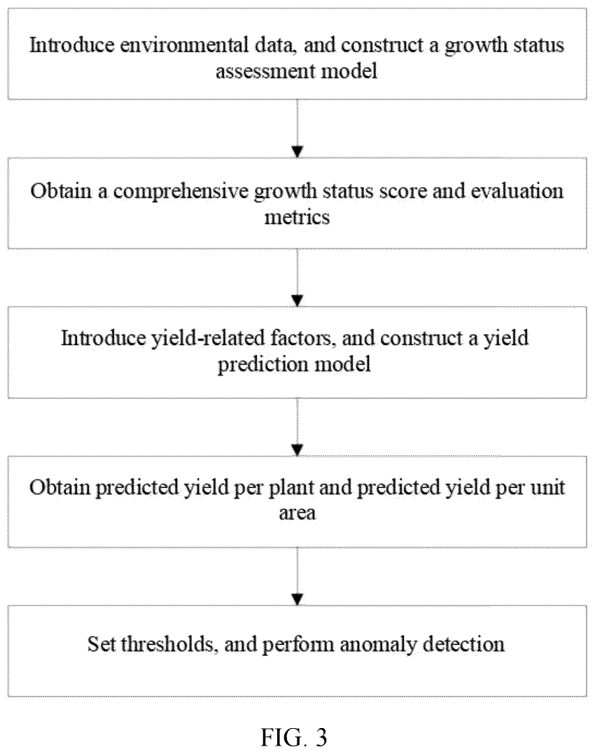

As shown in FIG. 3, this unit is configured to fuse the canopy coverage, plant height, vegetation index, textural features, environmental data, and yield-related factors (including plant density and boll load) to generate a yield prediction dataset; utilize the yield prediction dataset to train a yield prediction model, which incorporates an environmental correction factor to adjust output values; and employ the yield prediction model to output predicted yield per plant and predicted yield per unit area.

An expression for the predicted yield per plant area is given by:

$${Y}_{single} = B \cdot {W}_{boll}$$

where Y_{single} represents the predicted yield per plant, B represents a boll load, and W_{boil} is a weight per boll.

An expression for the predicted yield per unit area is given by:

$${Y}_{yield} = D \cdot {Y}_{single} \cdot ( 1 - {k}_{1} \cdot \vert {E}_{soil} - {E}_{opt} \vert - {k}_{2} \cdot \vert {E}_{temp} - {T}_{opt} \vert )$$

where Y_{yield} represents the predicted yield per unit area, D represents plant density, Eₒₚₜ represents optimal soil moisture, Tₒₚₜ represents optimal growth temperature, and k₁ and k₂ are environmental correction coefficients.

### 5.2 Growth Anomaly Unit

This unit is configured to set thresholds for the comprehensive growth status score, health index, and stress index based on the output values from the growth status assessment model, determine whether a cotton field plot constitutes an anomalous area according to the set thresholds, and automatically generate an alert message if so. The alert message includes the location of anomalous areas (latitude and longitude coordinates), analysis of anomalous causes (e.g., drought, pest/disease), and recommended control measures (e.g., irrigation, fertilization, pesticide application).

### 6. Real-Time Monitoring and Decision Support Module

This module is configured to utilize a cloud service platform for distributed data storage and management, employ WebGIS technology to visually display comprehensive assessment and growth prediction results for individual cotton plots, and automatically generate and execute decision support for automated field management based on the comprehensive assessment and growth prediction results. Additionally, the real-time monitoring and decision support module includes:

### 6.1 Data Storage Unit

This unit is configured to store structured data (such as health indices and yield predictions) in a relational database and manage unstructured data (including UAV imagery and orthophotos) via object storage using a cloud service platform (e.g., AWS, Google Cloud, Alibaba Cloud), and to perform real-time data ingestion through APIs.

### 6.2 Monitoring and Visualization Unit

This unit is configured to develop a responsive interface supporting multi-terminal access using front-end frameworks and to leverage WebGIS technology for real-time display of processing results from the image mining module, the comprehensive assessment module, and the growth prediction module on the interface in real time through map overlays, field plot views, and heatmaps.

Map overlay: open-source GIS frameworks (e.g., Leaflet, OpenLayers) or commercial platforms (such as ArcGIS Online) are utilized to implement map overlay functionality. Multiple information layers (such as health index, canopy coverage, soil moisture, and pest/disease distribution) are displayed on the map.

Field plot view: growth data organized by individual plots are displayed. By clicking on a plot, detailed information (such as historical growth trends and predicted yield) is revealed.

Heatmap: spatial heatmaps of the health index and stress index are generated to visually display areas with anomalous growth.

### 6.3 Decision Support Unit

This unit is configured to generate fertilization and irrigation recommendations, disease and pest control management suggestions, climate change trend analysis (assessing the long-term impact of climate change on cotton growth, such as the effect of increased drought frequency on yield), and pest/disease pattern analysis (utilizing data mining algorithms, e.g., association rule mining, to uncover temporal and environmental patterns of pest/disease occurrence) based on the processing results from the image mining module, the comprehensive assessment module, and the growth prediction module.

Therefore, the present disclosure provides a field-grown cotton growth status assessment and prediction system based on UAV RGB imagery. This system can perform a comprehensive analysis of cotton growth by integrating multiple factors, thereby enhancing the comprehensiveness, accuracy, and efficiency of assessment and prediction. Furthermore, this system can conduct real-time monitoring and support intelligent decision-making throughout the entire cotton growth cycle, thereby improving the efficiency and precision of agricultural management and propelling cotton precision agriculture into a new digital and intelligent stage.

In the specification, the embodiments are described in progressive order. Each embodiment primarily emphasizes distinctions from other embodiments, while identical or similar aspects across embodiments may be cross-referenced.

Herein, the specific examples are applied to explain the principles and implementations of the present disclosure, and the above embodiments are illustrated only to assist in understanding the methods and core ideas of the present disclosure. Meanwhile, for those ordinary skilled in the art, the specific implementations and the applied range may be changed according to the ideas of the present disclosure. In conclusion, the contents of the specification are not to be construed as a limitation to the present disclosure.

1. A field-grown cotton growth status assessment and prediction system based on unmanned aerial vehicle (UAV) red-green-blue (RGB) imagery, comprising:
a data acquisition module, configured to select a UAV equipped with an RGB camera, preset a flight path and image acquisition parameters according to terrain of a field plot, and perform data acquisition to obtain initial image data;
a data processing module, configured to perform denoising, distortion correction, orthophoto mosaic, and illumination correction on the initial image data to obtain standardized image data;
an image mining module, configured to perform image segmentation and object detection on the standardized image data to obtain cotton target information, and extract canopy coverage, plant height, color features and vegetation indices, as well as textural and spatial structural features from the cotton target information, ultimately obtaining cotton canopy profile features and growth indicators;
a comprehensive assessment module, configured to incorporate environmental data, train a machine learning model using the environmental data and the growth indicators to obtain a growth status assessment model, and utilize the assessment model to obtain a comprehensive growth condition score and evaluation metrics;
a growth prediction module, configured to perform yield prediction by incorporating yield-related factors based on the growth status assessment model, and to issue growth anomaly warnings by presetting growth anomaly thresholds; and
a real-time monitoring and decision support module, configured to utilize a cloud service platform for distributed data storage and management, employ WebGIS technology to visually display comprehensive assessment and growth prediction results for individual cotton plots, and automatically generate and execute decision support for automated field management based on the comprehensive assessment and growth prediction results;
wherein
the data acquisition module, the data processing module, the image mining module, the comprehensive assessment module, the growth prediction module, and the real-time monitoring and decision support module are interconnected.

2. The field-grown cotton growth status assessment and prediction system based on UAV RGB imagery according to claim 1, wherein the data acquisition module comprises:
a hardware configuration unit, configured to select a UAV, and equip the selected UAV with an RGB camera mounted on a compatible three-axis gimbal to achieve image stabilization;
a flight path planning unit, configured to automatically generate a flight path using UAV route planning software, and to set a forward overlap degree and a side overlap degree for image capture; and
a parameter configuration unit, configured to set a flight altitude and an imaging resolution of the UAV according to cotton growth stages, and to execute data acquisition, ultimately obtaining the initial image data.

3. The field-grown cotton growth status assessment and prediction system based on UAV RGB imagery according to claim 2, wherein the data processing module comprises:
a denoising and distortion correction unit, configured to perform denoising on the initial image data using an automatic batch processing tool and a denoising algorithm, and to perform distortion correction on image edges using camera calibration parameters;
an orthophoto mosaic unit, configured to process overlapping images from the initial image data using photogrammetric software by performing feature point matching and image stitching, outputting a georeferenced orthophoto; and
an illumination correction unit, configured to deploy a gray-level card within a UAV flight area to record reference reflectance values, perform color calibration on the initial image data based on the values, and integrate a radiometric correction algorithm into the photogrammetric software to standardize image brightness and color.

4. The field-grown cotton growth status assessment and prediction system based on UAV RGB imagery according to claim 3, wherein the image mining module comprises:
a data annotation unit, configured to perform pixel-level annotation on the standardized image data using annotation tools, generating segmentation masks to distinguish cotton plants from a soil background, and to apply bounding box annotations to individual cotton plants and disease/pest infestation areas;
an image segmentation unit, configured to: construct a first initial model by selecting a convolutional neural network (CNN), incorporating an attention mechanism, a multi-scale feature extraction module, and depthwise separable convolutions into the selected CNN; train the first initial model using a deep learning framework to obtain a segmentation model; and employ the segmentation model to process the standardized image data and output a binary image containing overall distribution information of the cotton canopy;
a target detection unit, configured to develop an object detection model by integrating YOLOv5 with multi-task learning, and to utilize the object detection model to detect targets within the binary image, outputting positional information comprising locations of individual cotton plants or disease/pest infestation areas;
a result fusion unit, configured to fuse the binary image with the positional information to obtain cotton target information; and
a canopy profile and growth indicator extraction unit, configured to extract canopy coverage, plant height, color features and vegetation indices, as well as textural and spatial structural features from the cotton target information, ultimately obtaining the associated canopy profile features and growth indicators.

5. The field-grown cotton growth status assessment and prediction system based on UAV RGB imagery according to claim 4, wherein the canopy profile features and growth indicators extraction unit comprises:
a canopy coverage calculation subunit, configured to calculate canopy coverage by determining a percentage of cotton canopy pixels in the binary image, and assess whether growth progress is normal based on the canopy coverage combined with the cotton growth stages;
a plant height estimation subunit, configured to estimate plant height by combining the orthophoto with a digital surface model (DSM), and to output a spatial distribution map of plant height for identifying areas with anomalous growth;
a textural and spatial structural feature extraction subunit, configured to extract textural features from the standardized image data using a gray-level co-occurrence matrix (GLCM), and to calculate population density and inter-plant spacing of cotton plants, ultimately obtaining the spatial structural features; and
a color feature and vegetation index calculation subunit, configured to extract RGB color features from the standardized image data, design RGB vegetation indices by integrating the textural features with the color features, and assess cotton health status and identify disease/pest infestation areas based on spatial distribution of the RGB vegetation indices.

6. The field-grown cotton growth status assessment and prediction system based on UAV RGB imagery according to claim 5, wherein the comprehensive assessment module comprises:
a data fusion unit, configured to acquire soil data, meteorological data, and geographic information data for cotton fields to obtain environmental data, perform spatial and temporal alignment between the environmental data and the standardized image data, and fuse the aligned environmental data with the extracted growth indicators to obtain a comprehensive dataset;
a model construction unit, configured to build an initial model using ensemble learning methods, define input variables (comprising canopy coverage, plant height, vegetation indices, textural features, and environmental data) and output variables (comprising a comprehensive growth status score, a health index, and a stress index), and train the model using the comprehensive dataset to obtain the growth status assessment model; and
an indicator quantification unit, configured to generate a spatial distribution map based on the comprehensive growth status score, integrate the score with the health index and stress index to obtain the evaluation metrics, and perform a comprehensive assessment using the metrics.

7. The field-grown cotton growth status assessment and prediction system based on UAV RGB imagery according to claim 6, wherein
an expression for the comprehensive growth status score is formulated as:
$$S = {ω}_{1} \cdot C + {ω}_{2} \cdot H + {ω}_{3} \cdot VI + {ω}_{4} \cdot T$$
where S represents a comprehensive growth status score, C represents canopy coverage, H represents plant height, VI represents a vegetation index, T represents textural features, and ω₁, ω₂, ω₃, and ω₄ are weight coefficients for each indicator;
an expression for the health index is formulated as:
$$HI = α \cdot VI + β \cdot T$$
where HI represents a health index, and α and β are weight parameters; and
an expression for the stress index is formulated as:
$$AI = {γ}_{1} \cdot ( 1 - {E}_{soil} ) + {γ}_{2} \cdot \vert {E}_{temp} - {T}_{opt} \vert$$
where AI represents the stress index, Eₛₒᵢₗ represents soil moisture, Eₜₑₘₚ represents temperature, Tₒₚₜ represents an optimal growth temperature for cotton, and γ₁ and γ₂ are weight parameters.

8. The field-grown cotton growth status assessment and prediction system based on UAV RGB imagery according to claim 7, wherein the growth prediction module comprises:
a yield prediction unit, configured to fuse the canopy coverage, plant height, vegetation index, textural features, environmental data, and yield-related factors (comprising plant density and boll load) to generate a yield prediction dataset; utilize the yield prediction dataset to train a yield prediction model, which incorporates an environmental correction factor to adjust output values; and employ the yield prediction model to output predicted yield per plant and predicted yield per unit area; and
a growth anomaly unit, configured to set thresholds for the comprehensive growth status score, health index, and stress index based on the output values from the growth status assessment model, determine whether a cotton field plot constitutes an anomalous area according to the set thresholds, and automatically generate an alert message if so.

9. The field-grown cotton growth status assessment and prediction system based on UAV RGB imagery according to claim 8, wherein
an expression for the predicted yield per plant area is given by:
$${Y}_{single} = B \cdot {W}_{boll}$$
where Y_{single} represents the predicted yield per plant, B represents a boll load, and W_{boil} is a weight per boll; and
an expression for the predicted yield per unit area is given by:
$${Y}_{yield} = D \cdot {Y}_{single} \cdot ( 1 - {k}_{1} \cdot \vert {E}_{soil} - {E}_{opt} \vert - {k}_{2} \cdot \vert {E}_{temp} - {T}_{opt} \vert )$$
where Y_{yield} represents the predicted yield per unit area, D represents plant density, Eₒₚₜ represents optimal soil moisture, Tₒₚₜ represents optimal growth temperature, and k₁ and k₂ are environmental correction coefficients.

10. The field-grown cotton growth status assessment and prediction system based on UAV RGB imagery according to claim 9, wherein the real-time monitoring and decision support module comprises:
a data storage unit, configured to store structured data in a relational database and manage unstructured data via object storage using a cloud service platform, and to perform real-time data ingestion through application programming interfaces (APIs);
a monitoring and visualization unit, configured to develop a responsive interface supporting multi-terminal access using front-end frameworks, and to leverage WebGIS technology for real-time display of processing results from the image mining module, the comprehensive assessment module, and the growth prediction module on the interface in real time through map overlays, field plot views, and heatmaps; and
a decision support unit, configured to generate fertilization and irrigation recommendations, disease and pest control management suggestions, climate change trend analysis, and pest/disease pattern analysis based on the processing results from the image mining module, the comprehensive assessment module, and the growth prediction module.
